(19) United States
(12) Patent Application Publication
(10) Pub. No.: US 2007/0275355 A1
(43) Pub. Date: Nov. 29, 2007

(54) Integration and supervision for modeled and mechanical vehicle testing and simulation

(76) Inventors: William J. Langer, Minnetrista, MN (US); Daniel Barsness, Victoria, MN (US); Thomas D. Stachel, Apple Valley, MN (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/430,472

(22) Filed: May 8, 2006

(51) Int. Cl. G09B 9/02

(52) U.S. Cl. 434/29

(57) ABSTRACT

A supervisor module for managing vehicle testing is disclosed. The supervisor module includes logic configured to provide a startup and initialization function with respect to testing of a vehicle, logic configured to provide sequence control and event management with respect to testing of the vehicle, logic configured to receive simulation results from a simulator, the simulator configured to simulate operation with respect to the vehicle, logic configured to receive data resulting from actuation of a vehicle component, logic configured to analyze the simulation results and the data resulting from actuation of the vehicle component and generate one or more control signals based on the analysis, and logic configured to forward the one or more control signals to one or more actuators to dynamically actuate the vehicle component.

### FIELD

The embodiments of the present invention generally relate to the field of physical vehicle testing and evaluations and, more specifically, to methods and systems for providing vehicle testing on a real-time basis.

### BACKGROUND

Track tests and laboratory simulations are widely used in the automotive industry to evaluate and verify characteristics, designs and durability of a vehicle and/or a component or subsystem thereof. However, both track tests and conventional laboratory simulations have their drawbacks.

Track tests usually are time consuming and expensive. In track tests, actual vehicles are typically tested on the road under operating conditions. Data is captured and then subsequently forwarded to another location for analysis. The analyses are performed at a later time after the track tests. In some cases, track tests are impractical or even impossible because the finalized design of a new vehicle may be unavailable for track test. As a result, the interactions amongst the one or more subsystems of the vehicle may not be tested.

One type of simulation called hardware-in-the-loop (HIL) uses mathematical vehicle models to simulate the interactions between the vehicle and a circuit prototype in order to evaluate the design of a circuit. Conventional HIL simulations, though less expensive than track tests, only evaluate electronic signals and software between the circuit under test and the vehicle model, but do not test the combination of electronic, software and mechanical components of the vehicle collectively in the presence of physical loads.

Furthermore, in durability tests, test conditions are applied to a component or subsystem for a specified number of repetitions or until a component or subsystem failure occurs. The durability tests assume that the characteristics of the component or subsystem under test remain unchanged during the test process, and hence the testing conditions and vehicle models do not change. However, in reality, the characteristics of the component under durability tests change over time and, in turn, affect the vehicle model and test parameters or test conditions. For instance, a vehicle suspension under test may change as a load history is applied repeatedly. On the road, this would mean that the actual loads applied to the suspension also change because of its changing interaction with the vehicle and the road. If the simulation does not consider the changes in the test parameters or conditions, the test results would likely be less reliable.

Therefore, it would be desirable to provide an integrated vehicle simulation system for testing and evaluating the combination of electronic, software and mechanical components collectively. Moreover, it would also be desirable to provide an integrated vehicle simulation system that dynamically addresses the changes in the characteristics of the component under test.

### SUMMARY

This disclosure describes embodiments of vehicle simulations that address some or all of the above-described issues.

In one embodiment, a system for managing vehicle testing is disclosed. The system includes a simulator configured to simulate operation of a vehicle and generate simulation results, a mechanical loading device configured to actuate a vehicle component to be tested, and a supervisor module. The supervisor module is configured to: provide a startup and initialization function with respect to testing of the vehicle; provide sequence control and event management with respect to testing of the vehicle; receive the simulation results from the simulator; receive data resulting from actuation of the vehicle component; generate one or more control signals based on the simulation results and the data resulting from actuation of the vehicle component; and forward the one or more control signals to the one or more actuators to dynamically actuate the vehicle component.

In another embodiment, a supervisor module for managing vehicle testing is disclosed. The supervisor module includes: logic configured to provide a startup and initialization function with respect to testing of a vehicle; logic configured to provide sequence control and event management with respect to testing of the vehicle; logic configured to receive simulation results from a simulator, the simulator configured to simulate operation with respect to the vehicle; logic configured to receive data resulting from actuation of a vehicle component; logic configured to analyze the simulation results and the data resulting from actuation of the vehicle component and generate one or more control signals based on the analysis; and logic configured to forward the one or more control signals to one or more actuators to dynamically actuate the vehicle component.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIG. 1 is a simplified schematic block diagram illustrating an embodiment of the present invention.

### DETAILED DESCRIPTION

For illustration purposes, the following descriptions describe one or more illustrative embodiments of testers for testing a vehicle, such as an automobile and truck, etc.; and/or one or more subsystems thereof, such as an active suspension system, active rolling control system, etc. It will be apparent, however, to one skilled in the art that concepts of the disclosure may be practiced or implemented without these specific details. In other instances, well-known structures and devices are shown in block diagram form in order to avoid unnecessarily obscuring the present disclosure.

In one aspect, an integrated system is disclosed for testing a vehicle using a real-time model. The physical unit under test may include a vehicle, such as, an automobile. The automobile may include various subsystems for performing different functions, such as, power train, driver interface, climate and entertainment control, network interface, lighting, safety, engine, braking, steering, tires, chassis, etc. Each subsystem may further include components, parts and other subsystems. For instance, a power train subsystem may include a transmission controller, a continuously variable transmission (CVT) control, an automated manual transmission system, a transfer case, an all wheel drive (AWD) system, an electronic stability control system (ESC), a traction control system (TCS), etc. A chassis subsystem may include active dampers, magnetic active dampers, body control actuators, load leveling, anti-roll bars, etc. Designs and durability of these subsystems need to be tested and verified during the design and manufacturing process.

Some of the subsystems use electronic control units (ECUs) that actively monitor the driving conditions of a vehicle and dynamically adjust the operations and/or characteristics of the subsystems in order to provide better control or comfort.

Another example of active subsystems is an active suspension system. An active suspension system includes an ECU, adjustable shocks and springs, a series of sensors at each wheel and throughout the vehicle, and an actuator or servo atop each shock and spring. When the automobile drives over a pothole, the sensors pick up yaw and transverse body motion, and sense excessive vertical travel due to the pothole. The ECU collects, analyzes and interprets the sensed data and, in response, directs the actuator atop the shock and spring to change the damping set point. To accomplish this, an engine-driven oil pump sends additional fluid to the actuator, which increases spring tension, thereby reducing body roll, yaw, and spring oscillation.

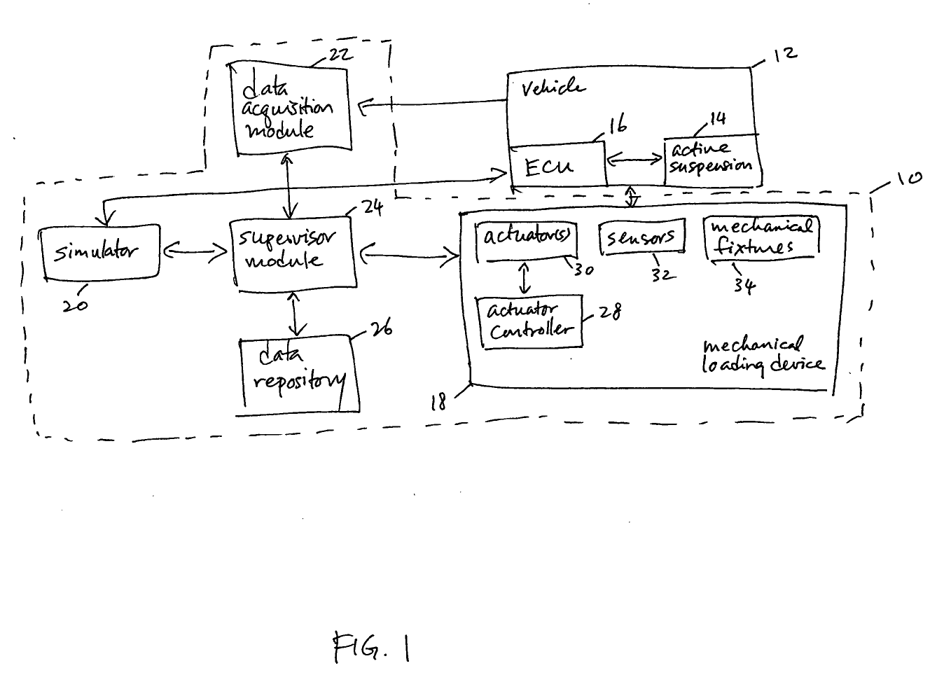

FIG. 1 illustrates an embodiment of an integrated dynamic testing system 10 that is designed to test the combination of electronic, software and mechanical components of an active suspension system in a vehicle 12. As described above, an active suspension system includes an active suspension 14 and an ECU 16 that is used to control the active suspension 14.

The system 10 may include a mechanical loading device 18, a simulator 20, a supervisor module 22, a data acquisition module 22 and a data repository 26. The mechanical loading device 18 may further include an actuator controller 28, one or more actuators 30, one or more sensors 32 and a number of mechanical fixtures 34. The actuator controller 28 is used to control the actuators 30. The actuators 30 are used to actuate the active suspension 14 and/or the body of the vehicle 12. The sensors 32 are used to capture data due to the actuation. The mechanical fixtures 34 are used to connect the actuators 30 to the vehicle 12.

A test may be performed with a complete or incomplete vehicle 12, or even without a vehicle 12 at all. In alternative embodiments, the system 10 may be used to test one or more subsystems of the vehicle 12.

The simulator 20 performs real-time simulations of the operation of a vehicle under selected test conditions based on a simulation model related to the vehicle 12. The construction and use of the simulation model depends on whether the active suspension 14 is tested with a complete or incomplete vehicle 12, or without the vehicle 12 at all. Other information included in the simulation model includes information related to an engine model, drive train model, tire model, or any other components relevant to the suspension. Physical parts of the vehicle 12 or suspension that are not present are modeled and incorporated into the simulator 20. The simulation model uses parameters or other data to simulate the desired properties of the vehicle 12 and/or the active suspension 14. Modeling techniques are widely used and known to people ordinarily skilled in the art. Companies supplying tools for building simulation models include, for example, Tesis, dSPACE, AMESim, Simulink. Companies that provide the simulator 20 include, for example, dSPACE, ETAS, Opal RT, A&D, etc. A typical vehicle simulation model includes at least one of engine, power train, suspension, wheel and tires, vehicle dynamics, aerodynamics, driver behavior patterns, road conditions, brakes, body mass, center of gravity, passenger load, cargo load, body dimensions, thermal dynamic effects, clutch/torque converter, etc.

The simulator 20 has access to a test condition database which includes data related to a road profile, a driving course, a driver's inputs, a surface definition, a driver model, test scenario, speed, direction, driving maneuvers, braking, etc. In one embodiment, a road profile includes a map of the road surface elevation versus distance traveled, vehicle turns, etc. The driver's inputs may be pre-stored or input by an operator of the system 10. The operator may follow an arbitrary sequence (open loop driving), or the operator may adjust inputs in response to the current vehicle path as seen on a display of the system 10 (closed loop driving). The inputs may include brake pressure, throttle position, and possibly steer wheel position. The simulator 20 provides signals to the ECU 16 which, in turn, controls the active suspension 14.

The simulator 20 may be implemented using a data processing system, such as, a computer, that includes one or more data processors for processing data, a data storage device configured to store instructions and data related to the simulation model, test condition database, etc. The instructions, when executed by the data processor, are designed to control the simulator 20 to perform various desired functions. In one embodiment, the simulator 20 may be a HIL simulator, although other types of real-time simulators may be used.

In operation, the simulator 20 generates respective signals to the ECU 16 and the supervisor module 20 based on the simulation model and data stored in the test condition database. Furthermore, the simulator 20 provides the ECU 16 with information related to the operation of the vehicle 12 under the specific test condition using the simulation model. For instance, the simulation model simulates the operation and/or vehicle dynamics based on driver's inputs received from a file or directly from an operator. The simulator 20 computes vehicle velocity and the loads the chassis would impose on the suspension from acceleration. The driver's inputs may include throttle position, brake pressure and steer wheel displacement, etc.

In one embodiment, the simulation model includes a power train model assuming power proportional to the throttle position. Interrupted power according to a shift schedule will result in a change in body force actuator command due to the acceleration transient, similar to the road. Driver's brake input may result in a braking force in the vehicle dynamics model resulting in a decrease in vehicle speed and change in body force due to deceleration. Acceleration will determine the inertial load transfer to the suspension. Road loads for grade, air resistance and rolling loss are combined with vehicle inertia and power train output to determine vehicle displacement, velocity and acceleration along the road path. Road vertical displacement will be applied as in a real road. Path acceleration will determine the inertial load transfer to the suspension. A steering input may also be considered. Steer input will result in lateral and yaw velocity changes for the simulated vehicle. A tire model can be used to produce the lateral forces as a function of slip angle and normal force. For simplicity, the road profile may be superimposed on the path that the vehicle takes to eliminate the necessity of an x-y description of the road plane. Steering inputs will result in a change in normal force to the suspension corner under test.

Based on the information provided by the simulator 20, the ECU 16 sends out commands to change the characteristics of the active suspension 14 which, in turn, changes the resulting body and suspension loads/position of the vehicle 12. Sensors 32 are provided in appropriate portions of the active suspension 14 and/or the vehicle 12 to obtain signals representing the responses to test conditions applied by the actuators 30 and changes of the physical characteristics initiated by the ECU 16. Examples of the response signals may include a deflection angle of the steering system, a camber angle, a vertical force and aligning torque, etc.

The supervisor module 24 is configured to perform a number of functions including (1) providing startup and initialization function, (2) providing sequence control, (3) handling event management, (4) facilitating communications amongst various components of the system 10, and (5) providing a user interface.

The supervisor module 24 provides a startup and initialization function in order to allow the vehicle 12 to be tested properly, for example, by ensuring that a simulation model and the vehicle 12 are synchronized before a testing sequence is initiated. To provide such function, the supervisor module 24 first establishes certain known boundary conditions for the vehicle 12 to be tested. The supervisor module 24 then relaxes constraints in the initial state and allows the vehicle 12 to reach a new equilibrium. Based on the new equilibrium, the supervisor module 24 adjusts the mechanical loading device 18 such as measurements (e.g., force, position, etc.) obtained from the vehicle 12 match the new equilibrium.

The supervisor module 24 also provides sequence control for testing the vehicle 12. The supervisor module 24 may control and permit definition of a testing sequence, for example, by verifying that the definition is accurate. A sequence or definition is a string of conditions that are to be used to test the vehicle 12. The conditions may include road course conditions, loading conditions (e.g., passenger load, tire pressure etc.), atmospheric conditions and other test/evaluation conditions, etc.

To complement the sequence control, the supervisor module 24 further handles event management. When a string of conditions are tested, certain events or exceptions may occur. The supervisor module 24 is configured to detect such events or exceptions and handle them accordingly.

The supervisor module 24 is further configured to coordinate and synchronize the operations of the system 10. The supervisor module 24 is able to facilitate communications amongst various components of the system 10 including, for example, the simulator 20, the ECU 16, the data acquisition module 22, the data repository 26 and the mechanical loading device 18. Information or data is gathered by the supervisor module 24 and then distributed to the appropriate components. Such information or data may related to state signals, event transitions, command signals, physical measurements, etc. The supervisor module 24 may also communicate with a number of network interfaces, analysis tools and other software applications (not shown).

The supervisor module 24 may also synchronize sensor and/or output data from various components of the system 10 for real-time operations or post processing analysis.

The supervisor module 24 may further provide a gateway or user interface that is used by an operator to access and/or manage test system information, such as, system status data and other data, such as, those residing in the data repository 26.

As shown in FIG. 1, in operation, the supervisor module 24 receives signals from the simulator 20 and data from the data acquisition module 22 and data repository 26 on a real-time basis. In response, the supervisor module 24 performs the appropriate analysis(es) and generates the appropriate control signals for the mechanical loading device 18. Using the control signals provided by the supervisor module 24, the actuator controller 28, in turn, directs the actuator(s) 30 to perform the appropriate action(s) including, for example, adjusting the body of the vehicle 12 and/or the active suspension 14. The results and/or effects of such action(s) are then captured by sensors 32 and then provided to the data acquisition module 22 in real-time. The supervisor module 24 then dynamically performs its analysis(es) based on the data provided by the data acquisition module 22 and readjusts the control signals for the mechanical loading device 18 accordingly.

It should be noted while the description provided above in connection with FIG. 1 is in the context of testing an active suspension, the system 10 may be used to test other components and/or subsystems of a vehicle including, for example, other passive components that do not require use of any ECUs.

It should be further noted that the system 10 may be used in other applications as well including, for example, testing of civil engineering structures (such as, buildings, bridges, etc.), biomedical devices and implants and materials.

The various illustrative logical blocks, modules, circuits, elements, and/or components described in connection with the embodiments disclosed herein may be implemented or performed with various types of hardware including, for example, a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the embodiments disclosed herein may be embodied directly in hardware, in a software module executable by a processor, or in a combination of both, in the form of control logic, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than a restrictive sense.

We claim:

1. A system for managing vehicle testing, comprising:
a simulator configured to simulate operation of a vehicle and generate simulation results;
a mechanical loading device configured to actuate a vehicle component to be tested; and
a supervisor module configured to:
provide a startup and initialization function with respect to testing of the vehicle;
provide sequence control and event management with respect to testing of the vehicle;
receive the simulation results from the simulator;
receive data resulting from actuation of the vehicle component;
generate one or more control signals based on the simulation results and the data resulting from actuation of the vehicle component; and
forward the one or more control signals to the one or more actuators to dynamically actuate the vehicle component.

2. The system of claim 1 wherein the supervisor module is further configured to receive the simulation results from the simulator on a real-time basis.

3. The system of claim 1 wherein the supervisor module is further configured to facilitate communication amongst the simulator, the mechanical loading device, a data acquisition module and a data repository.

4. The system of claim 3 wherein the supervisor module is further configured to include a user interface to allow an operator to coordinate actions amongst the supervisor module, the simulator, the mechanical loading device, the data acquisition module and the data repository.

5. The system of claim 1 wherein the mechanical loading device includes an actuator configured to actuate the body of the vehicle.

6. The system of claim 1 wherein the mechanical loading device includes an actuator configured to actuate a suspension associated with the vehicle.

7. The system of claim 1 wherein the vehicle component to be tested includes an active suspension system having an electronic control unit and an active suspension; and
wherein the simulator is further configured to communicate with the electronic control unit.

8. The system of claim 1 wherein the simulator includes a hardware-in-the-loop (HIL) simulator.

9. The system of claim 1 wherein the supervisor module is further configured to allow an operator to define and control a testing sequence with respect to the vehicle component.

10. A supervisor module for managing vehicle testing, comprising:
logic configured to provide a startup and initialization function with respect to testing of a vehicle;
logic configured to provide sequence control and event management with respect to testing of the vehicle;
logic configured to receive simulation results from a simulator, the simulator configured to simulate operation with respect to the vehicle;
logic configured to receive data resulting from actuation of a vehicle component;
logic configured to analyze the simulation results and the data resulting from actuation of the vehicle component and generate one or more control signals based on the analysis; and
logic configured to forward the one or more control signals to one or more actuators to dynamically actuate the vehicle component.

11. The supervisor module of claim 10 further comprising:
logic configured to receive the simulation results from the simulator on a real-time basis.

12. The supervisor module of claim 10 further comprising:
logic configured to facilitate communication amongst the simulator, the mechanical loading device, a data acquisition module and a data repository.

13. The supervisor module of claim 12 further comprising:
logic configured to include a user interface to allow an operator to coordinate actions amongst the supervisor module, the simulator, the mechanical loading device, the data acquisition module and the data repository.

14. The supervisor module of claim 10 wherein the mechanical loading device includes an actuator configured to actuate the body of the vehicle.

15. The supervisor module of claim 10 wherein the mechanical loading device includes an actuator configured to actuate a suspension associated with the vehicle.

16. The supervisor module of claim 10 wherein the vehicle component to be tested includes an active suspension system having an electronic control unit and an active suspension; and
wherein the simulator is further configured to communicate with the electronic control unit.

17. The supervisor module of claim 10 wherein the simulator includes a hardware-in-the-loop (HIL) simulator.

18. The supervisor module of claim 10 further comprising:
logic configured to allow an operator to define and control a testing sequence with respect to the vehicle component.
